(19) United States
(12) Patent Application Publication
(10) Pub. No.: US 2004/0045773 A1
(43) Pub. Date: Mar. 11, 2004

(54) Control device for tractor of transport truck

(76) Inventor: Everett Crough, Wetaskiwin (CA)

Correspondence Address: Ilya Zborovsky, 6 Schoolhouse Way, Dix Hills, NY, 11746, US

(21) Appl. No.: 10/234,375

(22) Filed: Sep. 5, 2002

(51) Int. Cl. B60T 7/20

(52) U.S. Cl. 188/3 H; 188/3 R

(57) ABSTRACT

A control system for a tractor of a transport truck system has a gear shift handle for a transmission, and an engine retard braking unit including a unit for generating an exhaust back pressure to slow the tractor, a switch for activating and deactivating the exhaust back pressure generating unit, and a sleeve fitted on the gear shift handle for the transmission, wherein the switch is located on the sleeve.

### BACKGROUND OF THE INVENTION

The present invention relates to control systems for tractors of transport trucks.

More particularly, it relates to engine retard brakes which are used for braking on tractors of transport trucks.

The engine retard brakes referred generally to as the “Jake-brakes” in the trucking industry, such as Jacob Engine Brake brand and Brake Saver brand by Caterpillar Corporation, use the exhaust back pressure to slow the vehicle. This makes a distinctive sound through the exhaust of a truck. The switch for the operation of this engine braking device is located traditionally on a dashboard of the tractor unit. Some solutions for such brakes are disclosed for example in U.S. Pat. Nos. 5,865,154; 5,315,900; 4,742,806; 5,679,093; design Pat. No. 366,439; European patent document EP 0672556 A1, the publication H. Eubanks “BD Engine Brakes; Kit to Slow Tow Vehicles on Downgrades; Evaluation; Trailer Life, September 1993, Volume 53, no. 9, page 74. Also, such systems have been produced by Spicer Transmissions as an aftermarket item for freightliner trucks. It is believed that the existing engine retard brakes can be further improved.

### SUMMARY OF THE INVENTION

Accordingly, it is an object of the present invention to provide a control system for tractors of transport trucks, which is a further improvement of the existing control systems.

In keeping with these objects and with others which will become apparent hereinafter, one feature of the present invention resides, briefly stated, in a control system for a tractor of a transport truck, comprising a gear shift handle attachment of a transmission, and an engine retard brake including means for generating an exhaust back pressure to slow the tractor, a switch for activating and deactivating said the exhaust back pressure generating means, and a sleeve fitted on the gear shift handle for the transmission, wherein the switch is located on the sleeve.

In accordance with another feature of the present invention the sleeve has a body provided with a central opening, the central opening is formed so that the gear shift handle passes through the central opening, the switch is located on the body the sleeve.

In accordance with a further feature of the present invention the body has two portions extending outwardly at both sides of the opening away from said gear shift lever, and the switch is located on one of the side portions.

In accordance with still a further feature of the present invention the body has a substantially vertical wall and a substantially horizontal upper surface, and the switch is located on the substantially horizontal upper surface.

When the control system is designed in accordance with the present invention, it has a simple construction and is easy and convenient to operate the engine related brake for providing an exhaust back pressure to slow the tractor.

In accordance with a further feature of the present invention, an engine related brake is provided which includes for generating an exhaust back pressure to slow the tractor, a switch for activating and deactivating the exhaust back pressure generating means and a sleeve fittable on said gear shift handle for the transmission, with the switch located on the sleeve.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

In accordance with a further feature of the present invention, a control system for a tractor of a transport truck, comprising a gear shift handle attachment of a transmission; an engine retard braking means including means for generating an exhaust back pressure to slow the tractor, a switch for activating and deactivating said exhaust back pressure generating means, and a sleeve fitted on said gear shift handle for the transmission, said switching being located on said sleeve.

### BRIEF DESCRIPTION OF THE DRAWINGS

FIG. 1 is a front view of an essential part of a control system for a tractor of a transport truck in accordance with the present invention; and

FIG. 2 is a plan view of the inventive control system shown in FIG. 1.

### DESCRIPTION OF THE PREFERRED EMBODIMENTS

A control system for a tractor of a transport truck has a gear shift lever which is identified with reference numeral 1. It is designed and used in a known manner to change gears of a transmission of the tractor during driving of the tractor. It is believed that any detailed description of the gear shift lever and its operation would be superfluous.

The control system in accordance with the present invention further includes an engine retard braking system which operates by generating an exhaust gas pressure to slow the tractor. The engine retard braking system includes means for generating an exhaust back pressure which are known per se and schematically shown in the drawings as a box identified with reference numeral 2.

The engine retard braking system further has a switch which is identified with reference numeral 3. A driver, by activating the switch 3, sends a signal to the exhaust back pressure generating means 2 so as to generate the exhaust back pressure and therefore to apply retard braking to a tractor of the transport truck, or to interrupt the signal and therefore to eliminate the exhaust back pressure and to stop the engine retard braking process.

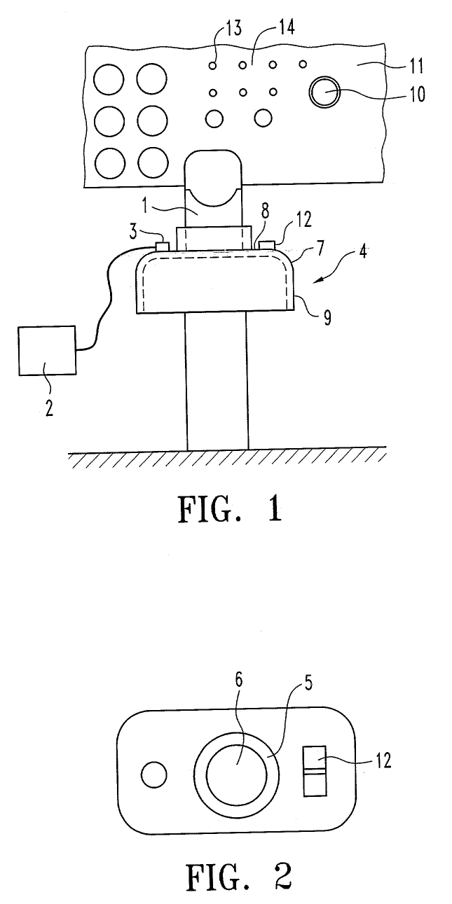

In accordance with the present invention, the engine retard braking system further includes a sleeve which is identified as a whole with reference numeral 4. The sleeve 4 has a central upwardly projecting collar 5 with a central opening 6, and a body part 7. The body part 7 includes an upper wall 8 and a peripheral wall 9 extending in two opposite directions. The body 7, as shown in FIG. 1, extends in two opposite directions from the central axis of the central opening 6 of the collar 5.

The sleeve 4 is fitted on the gear shift handle 1 by passing the gear shift handle 1 through the central opening 6 of the collar 5. As can be seen from the drawings, the switch 3 is located in the body 7. In particular, it is associated with the upper wall 8 of the body 7 and located at one side of the axis of the central opening 6 of the collar 5.

The device further has a three stage toggle or rocker switch 12 for the driver of the tractor to easily engage two or three different stages of the engine brake, depending on what type of engine brake is installed. i.e. Jacob Engine brand, etc. A red or orange light 13 indicates power on or off of the engine brake making it easy for driver to identify. A red or orange LED 14 displays the position of Stage 1, 2 or 3 depending on the type of engine brake installed in the tractor.

The switch 3 can be of any known design. It can be a push-button type switch, a toggle-lever type switch, etc.

When the switch 3 or switch 12 is located on the collar 7 in the manner shown in the drawings and explained herein above, it is easy for a driver to activate the switch and to deactive the switch. Also, since the switches are arranged in the collar 7, it is very easy to attach the switch 3 or the switch 12 together with the sleeve to the gear shift levers 1 of the existing tractors.

The system further includes an indicator for indicating the process of engine retard braking. It can be formed in a known manner as a light emitting diode 10 which is arranged on a dashboard of the tractor 11.

It is to be understood that the switch 3 or switch 12 can be located in the sleeve 7 at somewhat different places, and not exactly as shown in the drawings, but so as to provide in any way a convenience for the driver to active and to deactivate the switch.

It will be understood that each of the elements described above, or two or more together, may also find a useful application in other types of constructions differing from the types described above.

While the invention has been illustrated and described as embodied in control device for tractor of transport truck, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A control system for a tractor of a transport truck, comprising a gear shift handle for a transmission; an engine retard brake including means for generating an exhaust back pressure to slow the tractor, a switch for activating and deactivating said exhaust back pressure generating means, and a sleeve fitted on said gear shift handle, said switch being located on said sleeve.

2. A control system as defined in claim 1, wherein said sleeve has a body provided with a central opening, said central opening being formed so that said gear shift handle passes through said central opening, said switch being located on said body of said sleeve.

3. A control system as defined in claim 2, wherein said body has two side portions extending outwardly at both sides of said opening away from said gear shift handle, said switch being located on one of said side portions.

4. A control system as defined in claim 3, wherein said body has a substantially vertical wall and a substantially horizontal upper surface, said switch being located on said substantially horizontal upper surface.

5. A control system as defined in claim 1; and further comprising a switch for facilitating driver's engagement of stages of the engine brake.

6. A control system as defined in claim 1; and further comprising a light indicating a power on or off of the engine brake.

7. An engine retard brake for a tractor of a transport truck, comprising means for generating an exhaust back pressure to slow the tractor, a switch for activating and deactivating said exhaust back pressure generating means, and a sleeve fittable on a gear shift handle for the transmission of the tractor, said switch being located on said sleeve.
